(19) United States
(12) Patent Application Publication
(10) Pub. No.: US 2023/0306954 A1
(43) Pub. Date: Sep. 28, 2023

(54) SPEECH SYNTHESIS METHOD, APPARATUS, READABLE MEDIUM AND ELECTRONIC DEVICE

(71) Applicant: BEIJING YOUZHUJU NETWORK TECHNOLOGY CO., LTD., Beijing (CN)

(72) Inventor: Junjie PAN, Beijing (CN)

(21) Appl. No.: 18/020,198

(22) PCT Filed: Oct. 26, 2021
(86) PCT No.: PCT/CN2021/126431

§ 371 Date: Feb. 7, 2023

(30) Foreign Application Priority Data
Nov. 20, 2020 (CN) 202011315115.1

(51) Int. Cl. G10L 13/02; G10L 13/08; G10L 25/18

(52) U.S. Cl. CPC G10L 13/02; G10L 13/08; G10L 25/18

(57) ABSTRACT

The present disclosure relates to a speech synthesis method, apparatus, readable medium and electronic device, which relates to the technical field of electronic information processing. The method comprises: acquiring a text to be synthesized and a specified emotion type (101), determining specified acoustic features corresponding to the specified emotion type (102), and inputting the text to be synthesized and the specified acoustic features into a pre-trained speech synthesis model, to acquire a target audio with the specified emotion type corresponding to the text to be synthesized which is output by the speech synthesis model (102). The acoustic features of the target audio match with the specified acoustic features, and the speech synthesis model is trained from a corpus without the specified emotion type.

### CROSS-REFERENCE TO RELATED APPLICATION

The present application is a national phase application of PCT/CN2021/126431 filed Oct. 26, 2021, which claims the priority right of Chinese Patent Application No. 202011315115.1 filed on Nov. 20, 2020, entitled “SPEECH SYNTHESIS METHOD, APPARATUS, READABLE MEDIUM AND ELECTRONIC DEVICE”, both of which are hereby incorporated by reference in their entireties.

### FIELD OF THE INVENTION

The present disclosure relates to the technical field of electronic information processing, in particular to a speech synthesis method, apparatus, readable medium and electronic device.

### BACKGROUND

With continuous development of electronic information processing technology, speech, as an important carrier used by people to obtain information, has been widely used in daily life and work. An application scenario involving speech usually include the processing of speech synthesis, which refers to synthesizing texts specified by the user into audio. In the process of speech synthesis, it is necessary to utilize the original sound library for generating the audio corresponding to the text. Data in the original sound library is usually emotionless, and correspondingly, the audio obtained by speech synthesis is emotionless, and the expressive force of the audio is weak. In order to make the audio by speech synthesis have emotion, it is necessary to create a sound library with emotion, which is difficult for those recording staffs because of the heavy workload and low efficiency.

### DISCLOSURE OF THE INVENTION

This section of the invention is provided in a brief form so as to introduce the concept idea, which will be described in detail in the following detailed description section. This section is not intended to identify key features or essential features of the claimed technical solutions, nor intended to limit the scopes of the claimed technical solutions.

In a first aspect, the present disclosure provides a speech synthesis method, comprising:

acquiring a text to be synthesized and a specified emotion type,

determining specified acoustic features corresponding to the specified emotion type, and

inputting the text to be synthesized and the specified acoustic features into a pre-trained speech synthesis model, to acquire a target audio with the specified emotion type corresponding to the text to be synthesized which is output by the speech synthesis model, wherein the acoustic features of the target audio match with the specified acoustic features, and the speech synthesis model is trained from a corpus without the specified emotion type.

In a second aspect, the present disclosure provides a speech synthesis apparatus, comprising:

an acquisition module configured to acquire a text to be synthesized and a specified emotion type,

a determination module configured to determine specified acoustic features corresponding to the specified emotion type, and

a synthesis module configured to input the text to be synthesized and the specified acoustic features into a pre-trained speech synthesis model, to acquire a target audio with the specified emotion type corresponding to the text to be synthesized which is output by the speech synthesis model, wherein the acoustic features of the target audio match with the specified acoustic features, and the speech synthesis model is trained from a corpus without the specified emotion type.

In a third aspect, the present disclosure provides a computer readable medium on which a computer program is stored, which, when executed by a processing device, implements the steps of the method described in the first aspect of the present disclosure.

In a fourth aspect, the present disclosure provides an electronic device, including:

a storage device on which a computer program is stored;

a processing device for executing the computer program in the storage device to realize the steps of the method according to the first aspect of the present disclosure.

In a fifth aspect, the present disclosure provides a computer program product including instructions, which, when executed by a computer, cause the computer to implement the steps of the method described in the first aspect.

Other aspects and advantages of the disclosure will be set forth in part in the following description.

### DESCRIPTION OF THE DRAWINGS

The above and other features, advantages and aspects of various embodiments of the present disclosure will become more apparent when taken in conjunction with the accompanying drawings and with reference to the following detailed description. Throughout the drawings, the same or similar reference numerals refer to the same or similar elements. It should be understood that the drawings are schematic, and the components and elements are not necessarily drawn to scale. In the attached drawings:

FIG. 1 is a flowchart of a speech synthesis method according to an exemplary embodiment;

FIGS. 2 (a) and (b) are schematic diagrams of an association relationship according to an exemplary embodiment;

FIG. 3 is a block diagram of a speech synthesis model according to an exemplary embodiment;

FIG. 4 is a flowchart of another speech synthesis method according to an exemplary embodiment;

FIG. 5 is a flowchart of training of speech synthesis model according to an exemplary embodiment;

FIG. 6 is a flowchart of another training of speech synthesis model according to an exemplary embodiment;

FIG. 7 is a flowchart of yet another training of speech synthesis model according to an exemplary embodiment;

FIG. 8 is a block diagram of a speech synthesis apparatus according to an exemplary embodiment;

FIG. 9 is a block diagram of another speech synthesis apparatus according to an exemplary embodiment;

FIG. 10 is a block diagram of an electronic device according to an exemplary embodiment.

### DETAILED DESCRIPTION OF PREFERRED EMBODIMENTS

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth here. On the contrary, these embodiments are provided for a more thorough and complete understanding of the present disclosure. It should be understood that the drawings and embodiments of this disclosure are only for illustrative purposes, and are not intended to limit the scope of protection of this disclosure.

It should be understood that the steps described in the method embodiments of the present disclosure can be performed in different order and/or in parallel. In addition, the method embodiments may include additional steps and/or omit the steps shown. The scope of the present disclosure is not so limited in this respect.

As used herein, the term “including” and its variations are open including, that is, “including but not limited to”. The term “based on” means “based at least in part”. The term “one embodiment” means “at least one embodiment”; The term “another embodiment” means “at least one other embodiment”; The term “some embodiments” means “at least some embodiments”. Relevant definitions of other terms will be given in the following description.

It should be noted that the concepts of “first” and “second” mentioned in this disclosure are only used to distinguish different devices, modules or units, and are not used to limit the order or interdependence of the functions performed by these devices, modules or units.

It should be noted that the modifications of “one” and “multiple” mentioned in this disclosure are illustrative rather than restrictive, and those skilled in the art should understand that unless the context clearly indicates otherwise, they should be interpreted as “one or more”.

The names of messages or information exchanged between multiple devices in this embodiment are only for illustrative purposes, and are not intended to limit the scope of these messages or information.

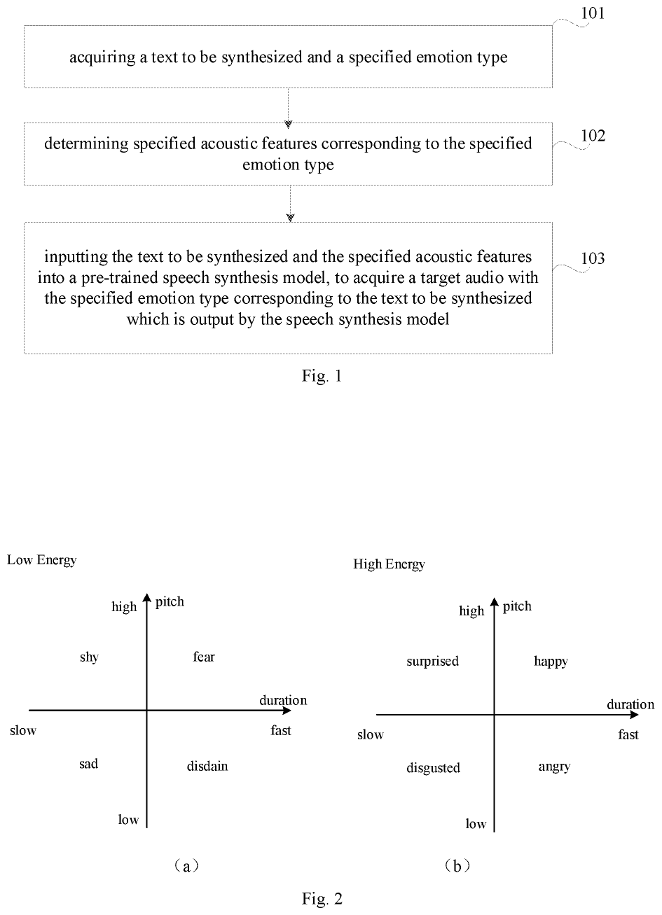

FIG. 1 is a flowchart of a speech synthesis method according to an exemplary embodiment, and as shown in FIG. 1, the method comprises:

Step 101, acquire a text to be synthesized and a specified emotion type.

For example, the text to be synthesized that needs to be synthesized is first acquired. The text to be synthesized can be, for example, one or more sentences, one or more paragraphs, or one or more chapters in a text file specified by the user. The text file can be, for example, an e-book or other types of files, such as news, official account articles, blogs, etc. In addition, a specified emotion type can also be acquired, the specified emotion type can be interpreted as an emotion type assigned by the user to which an audio synthesized from the text to be synthesized (i.e., the target audio as mentioned later) is expected to conform. The specified emotion type can be, for example, happy, surprised, disgusted, angry, shy, afraid, sad, disdainful, etc.

Step 102: determine specified acoustic features corresponding to the specified emotion type.

For example, people's sounds in different emotional states will have different acoustic features, so that the specified acoustic features that conform to the specified emotional type can be determined based on the specified emotional type. Among them, acoustic features can be interpreted as attributes of sound in multiple dimensions, such as volume (i.e. energy), fundamental frequency (i.e. pitch), speech speed (i.e. duration), etc. For example, the specified acoustic features corresponding to the specified emotion type can be determined according to correspondence relationships between emotion types and acoustic features, and the correspondence relationships between the emotion types and the acoustic features can be established in advance, for example, according to historical statistical data. A recognition model that can recognize acoustic features according to emotion types can be trained in advance, so that the specified emotion type can be input into the recognition model, and the output of the recognition model is the specified acoustic features. The recognition model can be, for example, a neural network such as RNN (Recurrent Neural Network), CNN (Convolutional Neural Network), LSTM (Long Short-Term Memory), which is not specifically limited in this disclosure.

Step 103: input the text to be synthesized and the specified acoustic features into a pre-trained speech synthesis model, to acquire a target audio with the specified emotion type corresponding to the text to be synthesized which is output by the speech synthesis model, wherein the acoustic features of the target audio match with the specified acoustic features, and the speech synthesis model is trained from a corpus without the specified emotion type.

For example, a speech synthesis model can be trained in advance, and the speech synthesis model can be interpreted as a TTS (Text To Speech) model, which can generate the target audio corresponding to the text to be synthesized and having the specified emotion type (that is, matching with the specified acoustic features) based on the text to be synthesized and the specified acoustic features. The text to be synthesized and the specified acoustic features are taken as the input of the speech synthesis model, and the output of the speech synthesis model is the target audio. Specifically, the speech synthesis model can be trained based on Tacotron model, Deepvoice 3 model, Tacotron 2 model, Wavenet model, etc., and is not specifically limited in this disclosure. Among them, in the process of training the speech synthesis model, there is no need for a corpus with the specified emotion type (which can be interpreted as a speech library), while the existing corpus without the specified emotion type can be directly used for training. In this way, in the process of speech synthesis of the text to be synthesized, in addition to semantics included in the text to be synthesized, the acoustic features corresponding to the specified emotion type are also considered, so that the target audio can have the specified emotion type. By means of the existing corpus without the specified emotion type, it can realize explicit control of emotion type in the process of speech synthesis, without spending a lot of time and labor costs to create the corpus with emotion in advance, which improves the expressive force of the target audio while improving the user's auditory experience.

To sum up, the present disclosure first acquires the text to be synthesized and the specified emotion type, then determines corresponding specified acoustic features based on the specified emotion type, and finally inputs the text to be synthesized and the specified acoustic features into a pre-trained speech synthesis model, and the output of the speech synthesis model is the target audio with the specified emotion type corresponding to the text to be synthesized, wherein the acoustic features of the target audio match with the specified acoustic features, and the speech synthesis model is trained from the corpus without the specified emotion type. The present disclosure can control the speech synthesis of text through the acoustic features corresponding to the emotion types, so that the target audio output by the speech synthesis model can correspond to the acoustic features, and the expressive force of the target audio can be improved.

In some embodiments, the specified acoustic features include at least one of fundamental frequency, volume and speech speed. Step 102 can be implemented in the following ways:

the corresponding specified acoustic features are determined based on the specified emotion type and the association relationships between emotion types and acoustic features.

The association relationships between emotion types and acoustic features can be determined in various appropriate ways. As an example, it can first acquire audios that conform to a certain emotion type, and then determine acoustic features in these audio by signal processing, labeling and other processing manners, so as to obtain the acoustic features corresponding to this emotion type. The above steps are repeated for a variety of emotion types, so as to get the association relationship between emotion types and acoustic features. Among them, the acoustic features can include at least one of fundamental frequency, volume and speech speed, and can further include tone, timbre, loudness, etc., which are not specifically limited in this disclosure. For example, as shown in FIG. 2, the association relationship can represent emotion types from three dimensions: fundamental frequency, volume and speech speed, in which (a) in FIG. 2 shows four corresponding emotion types in a scene with low volume (i.e. Low Energy): shy, fear, sad and disdain, and (b) in FIG. 2 shows four corresponding emotion types in a scene with high volume (i.e. High Energy): surprised, happy, angry, disgusted. Further, the association relationship can also be quantified. For example, (a) in FIG. 2 shows that shy is located in the second quadrant with low volume, and the acoustic features corresponding to shy can be determined as (volume: −2, fundamental frequency: +3, speech speed: −3).

In some embodiments, the target audio can be obtained by the speech synthesis model according to the following operations:

Firstly, text features corresponding to the text to be synthesized and predicted acoustic features corresponding to the text to be synthesized are obtained from the text to be synthesized.

Then, the target audio with the specified emotion type is obtained based on the specified acoustic features, predicted acoustic features and text features.

For example, in the specific process of synthesizing the target audio through the speech synthesis model, the text features corresponding to the text to be synthesized can be extracted first, and the acoustic features corresponding to the text to be synthesized can be predicted. Among them, text features can be interpreted as text vectors that can characterize the text to be synthesized. The predicted acoustic features can be interpreted as acoustic features conforming to the text to be synthesized predicted by the speech synthesis model based on the text to be synthesized. The predicted acoustic features can include at least one of fundamental frequency, volume and speed, and can further include tone, timbre and loudness, etc.

After obtaining the text features and the predicted acoustic features, the target audio with the specified emotion type can be generated by further combining the specified acoustic features. In one implementation, the specified acoustic features and the predicted acoustic features can be superimposed to obtain an acoustic feature vector, and then the target audio can be generated based on the acoustic feature vector and the text vector. In another implementation, the specified acoustic feature, the predicted acoustic feature and the text vector can be superimposed to obtain a combined vector, and then the target audio can be generated based on the combined vector, which is not specifically limited in this disclosure.

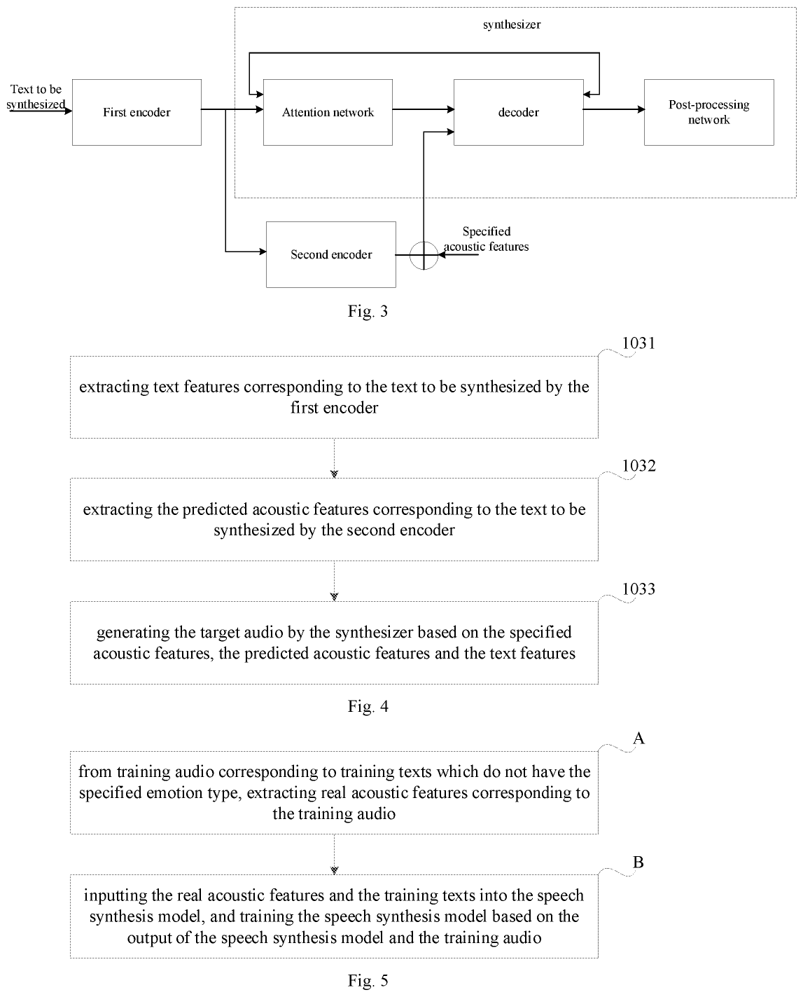

FIG. 3 is a block diagram of a speech synthesis model according to an exemplary embodiment. As shown in FIG. 3, the speech synthesis model includes a first encoder, a second encoder and a synthesizer. The structure of the first encoder can be the same as that of the encoder (Encoder) in Tacotron model, and the synthesizer can be interpreted as the combination of attention network (Attention), decoder (Decoder) and post-processing network (Post-processing) in Tacotron model. The second encoder (which can be expressed as Feature Extractor) can be interpreted as an extraction model, which can predict the acoustic features (i.e. the predicted acoustic features as mentioned later) corresponding to the input text from the text.

FIG. 4 is a flowchart of another speech synthesis method according to an exemplary embodiment. As shown in FIG. 4, step 103 may include:

Step 1031: Extract text features corresponding to the text to be synthesized by the first encoder.

For example, the first encoder may include an embedded layer (i.e., a Character Embedding layer), a pre-processing network (Pre-net) submodel and a CBHG (Convolution Bank+Highway Network+Bidirectional Gated Recursive Unit) submodel. The text to be synthesized is input into the first encoder, firstly, the text to be synthesized is converted into word vectors through the embedded layer, and then the word vectors are input into the Pre-net sub-model to perform nonlinear transformation on the word vectors, thus improving the convergence and generalization ability of the speech synthesis model. Finally, by means of the CBHG sub-model, the text features that can characterize the text to be synthesized can be obtained based on the word vectors after nonlinear transformation.

Step 1032, Extract predicted acoustic features corresponding to the text to be synthesized by the second encoder.

For example, the text features determined in step 1031 may be input to the second encoder, so that the second encoder predicts the predicted acoustic features corresponding to the text to be synthesized according to the text vector. The second encoder can be a 3-layer, 256-unit, 8-head Transformer, for example.

Step 1033, the target audio can be generated by the synthesizer based on the specified acoustic features, the predicted acoustic features and the text features.

Specifically, the synthesizer can include an attention network, a decoder and a post-processing network. The text features can be first input into the attention network, and the attention network can apply an attention weight to each element in the text vector, so that the text features with fixed length can be changed into semantic vectors with variable length, wherein the semantic vectors can characterize the text to be synthesized. Specifically, the attention network may be a Locative Sensitive Attention network, a GMM (Gaussian Mixture Model) attention network, or a Multi-Head Attention network, which is not specifically limited in this disclosure.

Furthermore, the specified acoustic features, the predicted acoustic features and the semantic vectors can be input into the decoder. In one implementation, the specified acoustic features and the predicted acoustic features can be superimposed to obtain an acoustic feature vector, and then the acoustic feature vector and the semantic vector can be taken as the input of the decoder. In another implementation, the specified acoustic features, predicted acoustic features and semantic vectors can be superimposed to obtain a combined vector, and then the combined vector can be taken as the input of the decoder. The decoder may include a preprocessing network submodel (which may be the same as the preprocessing network submodel included in the first encoder), Attention-RNN, and Decoder-RNN. The preprocessing network sub-model is used for nonlinear transformation of the input specified acoustic features, predicted acoustic features and semantic vectors. The structure of Attention-RNN is a one-layer unidirectional zoneout-based LSTM (Long Short-Term Memory) that can take the output of the preprocessing network sub-model as input, which is output to the Decoder-RNN after passing through the LSTM unit. Decode-RNN is a two-layer unidirectional zoneout-based LSTM, and the LSTM unit outputs Mel spectrum information, which may include one or more Mel spectrum features. Finally, the Mel spectrum information is input into the post-processing network, which may include a vocoder (e.g., Wavenet vocoder, Griffin-Lim vocoder, etc.) for converting the Mel spectrum feature information to obtain the target audio.

In some embodiments, the text feature may include multiple text elements, and the implementation of step 1033 may include:
Step 1) Through a synthesizer, the Mel spectrum features at the current moment can be determined based on current text elements, historical Mel spectrum features, specified acoustic features and predicted acoustic features, the current text elements are the text elements input to the synthesizer at the current moment, and the historical Mel spectrum features are the Mel spectrum features at the previous moment determined by the synthesizer.
Step 2) Through the synthesizer, the target audio is generated based on the Mel spectrum features at each moment.

For example, the text feature may include a first number of text elements (the first number is greater than 1), then correspondingly, the semantic vector output by the attention network in the synthesizer may include a second number of semantic elements, and the Mel spectrum information output by the decoder in the synthesizer may include a third number of Mel spectrum features. Among them, the first number, the second number and the third number may be the same or different, which is not specifically limited in this disclosure.

Specifically, the first number of text elements are input into the attention network in the synthesizer according to a preset timestep, and the text elements input into the attention network at the current moment are the current text elements, at the same time, the historical Mel spectrum features output by the decoder at the previous moment are also input into the attention network, so as to obtain the current semantic elements output by the attention network (the current semantic elements can be one or more semantic elements output by the attention network at the current moment). Accordingly, the specified acoustic features, predicted acoustic features, historical Mel spectrum features and current semantic elements can be input into the decoder in the synthesizer, to obtain the current Mel spectrum features output by the decoder. After all the text features are input into the attention network, the decoder will sequentially output the third number of Mel spectrum features, that is, Mel spectrum information. Finally, the Mel spectrum information (that is, the Mel spectrum features at each moment) is input into the post-processing network in the synthesizer, so as to obtain the target audio generated by the post-processing network.

FIG. 5 is a flowchart of a speech synthesis model training process according to an exemplary embodiment. The training process of the speech synthesis model can be included in the speech synthesis method according to the present disclosure, or can be outside of and applied to the speech synthesis method according to the present disclosure. As shown in FIG. 5, the speech synthesis model is obtained by training as follows:

Step A, from training audio corresponding to training texts which do not have the specified emotion type, extracting real acoustic features corresponding to the training audio.

Step B, inputting the real acoustic features and the training texts into the speech synthesis model, and training the speech synthesis model based on the output of the speech synthesis model and the training audio.

For example, to train the speech synthesis model, it is necessary to obtain the training texts and the training audio corresponding to the training texts. There can be multiple training texts, and correspondingly, there are also multiple training audio. For example, a large number of texts can be captured on the Internet as training texts, and then the audio corresponding to the training texts can be taken as the training audio, which may not have any emotional type. For the training text, the real acoustic features corresponding to the training audio without the specified emotion type can be extracted. For example, the real acoustic features corresponding to the training audio can be obtained through signal processing, labeling, etc. Finally, the training text and real acoustic features are used as the input of the speech synthesis model, and the speech synthesis model is trained based on the output of the speech synthesis model and the training audio. For example, the difference between the output of the speech synthesis model and the training audio is taken as the loss function of the speech synthesis model, and with the goal of reducing the loss function, a back propagation algorithm can be utilized to modify the parameters of neurons in the speech synthesis model, such as the Weight and Bias for the neurons. The above steps will be repeated until the loss function meets a preset condition, for example, the loss function is less than a preset loss threshold.

In some embodiments, the speech synthesis model may include a first encoder, a second encoder, and a synthesizer, and a blocking structure is arranged between the first encoder and the second encoder, and is used to prevent the second encoder from transmitting gradients back to the first encoder.

The blocking structure can be interpreted as stop_gradient ( ), which can intercept the second loss of the second encoder, thus preventing the second encoder from transmitting the gradients back to the first encoder. That is to say, when the second encoder is adjusted according to the second loss, the first encoder will not be affected, thus avoiding the problem of unstable training of speech synthesis model.

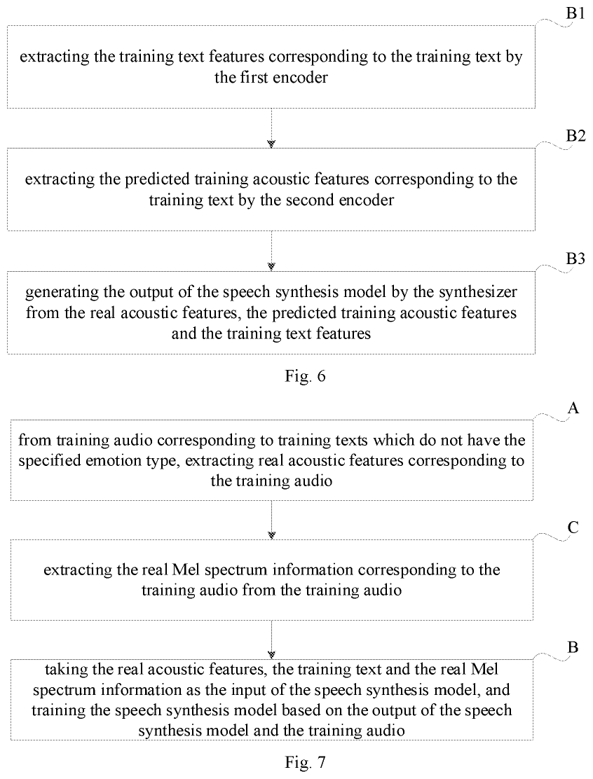

FIG. 6 is a flowchart of another process of training speech synthesis model according to an exemplary embodiment. As shown in FIG. 6, the implementation of step B may include:
Step B1, extracting the training text features corresponding to the training text by the first encoder.
Step B2, extracting the predicted training acoustic features corresponding to the training text by the second encoder.
Step B3, generating the output of the speech synthesis model by the synthesizer from the real acoustic features, the predicted training acoustic features and the training text features.

For example, the training text can be input into the first encoder to acquire the training text features output by the first encoder corresponding to the training text. Then, the training text features are input into the second encoder to acquire the predicted training acoustic features output by the second encoder corresponding to the training text features. Then, the real acoustic features, the predicted training acoustic features and the training text features are input into the synthesizer, and the output of the synthesizer is used as the output of the speech synthesis model.

In some embodiments, the loss function of the speech synthesis model is determined by a first loss and a second loss, the first loss is determined by the output of the speech synthesis model and the training audio, and the second loss is determined by the output of the second encoder and the real acoustic features.

For example, the loss function can be jointly determined by the first loss and the second loss, for example, the first loss and the second loss can be weighted and summed. Among them, the first loss can be interpreted as a loss function determined based on difference (or mean square error) between the output of the speech synthesis model, which is obtained by inputting the training text and the corresponding real acoustic features into the speech synthesis model, and the training audio corresponding to the training text. The second loss can be interpreted as a loss function determined based on difference (or mean square error) between the output of the second encoder, which is obtained by inputting the training text into the first encoder to obtain corresponding training text features and then inputting the training text features into the second encoder, and the real acoustic features corresponding to the training text. The weights can be set in various appropriate ways, such as based on the characteristics of the output of the second encoder. In this way, in the process of training the speech synthesis model, the weights and connections of neurons in the speech synthesis model can be adjusted as a whole, while the weights and connections of neurons in the second encoder can be adjusted at the same time, thus ensuring the accuracy and effectiveness of the speech synthesis model and the second encoder therein.

FIG. 7 is a flowchart of yet another process of training a speech synthesis model according to an exemplary embodiment. As shown in FIG. 7, the speech synthesis model can also be obtained by training as follows:

Step C, extracting the real Mel spectrum information corresponding to the training audio from the training audio.

Accordingly, step B can be: Taking the real acoustic features, the training text and the real Mel spectrum information as the input of the speech synthesis model, and training the speech synthesis model based on the output of the speech synthesis model and the training audio.

For example, in the process of training the speech synthesis model, the real Mel spectrum information corresponding to the training audio can also be obtained. For example, the real Mel spectrum information corresponding to the training audio can be obtained by signal processing. Accordingly, the real acoustic features, training text and real Mel spectrum information can be taken as the input of the speech synthesis model, and the speech synthesis model can be trained based on the output of the speech synthesis model and the training audio.

Specifically, the training text can be first input into the first encoder to obtain the training text features output by the first encoder corresponding to the training text. Then, the training text features are input into the second encoder to obtain the predicted training acoustic features output by the second encoder corresponding to the training text features. Then, the training text features and the real Mel spectrum information corresponding to the training text are input into the attention network, to obtain the training semantic vector output by the attention network corresponding to the training text. Then, the predicted training acoustic features, the training semantic vector, the real acoustic features corresponding to the training text, and the real Mel spectrum information corresponding to the training text are input into the decoder to obtain the training Mel spectrum information output by the decoder. Finally, the training Mel spectrum information is input into the post-processing network, and the output of the post-processing network is used as the output of the synthesizer (that is, the output of the speech synthesis model).

To sum up, the present disclosure first obtains the text to be synthesized and the specified emotion type, then determines the corresponding specified acoustic features according to the specified emotion type, and finally inputs the text to be synthesized and the specified acoustic features into a pre-trained speech synthesis model, and the output of the speech synthesis model is the target audio with the specified emotion type corresponding to the text to be synthesized, in which the acoustic features of the target audio match with the specified acoustic features, and the speech synthesis model is trained according to the corpus without the specified emotion type. The present disclosure can control the speech synthesis of texts based on the acoustic features corresponding to the emotion types, so that the target audio output by the speech synthesis model can correspond to the acoustic features, and the expressive force of the target audio can be improved.

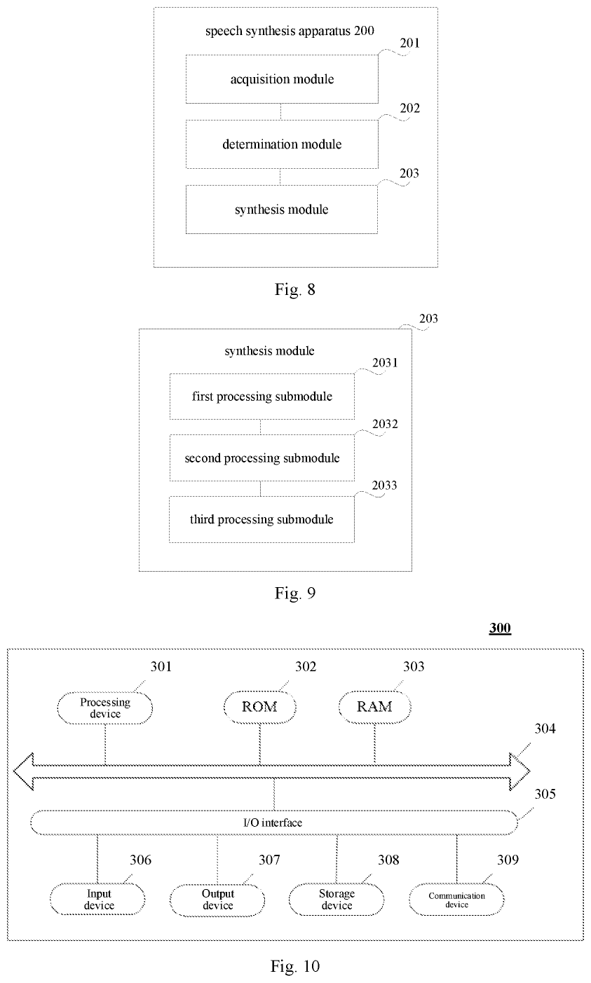

FIG. 8 is a block diagram of a speech synthesis apparatus according to an exemplary embodiment. As shown in FIG. 8, the apparatus 200 includes:

an acquisition module 201, configured to acquire a text to be synthesized and a specified emotion type,

a determination module 202, configured to determine specified acoustic features corresponding to the specified emotion type, and

a synthesis module 203, configured to input the text to be synthesized and the specified acoustic features into a pre-trained speech synthesis model, to acquire a target audio with the specified emotion type corresponding to the text to be synthesized which is output by the speech synthesis model, wherein the acoustic features of the target audio match with the specified acoustic features, and the speech synthesis model is trained from a corpus without the specified emotion type.

In some embodiments, the specified acoustic features include at least one of fundamental frequency, volume and speech speed, and the determination module 202 may be configured to:

determine the corresponding specified acoustic features based on the specified emotion type and preset association relationships between emotion types and acoustic features.

In some embodiments, the speech synthesis model can be configured to:

Firstly, obtain text features corresponding to the text to be synthesized and predicted acoustic features corresponding to the text to be synthesized from the text to be synthesized.

Then, obtain target audio with the specified emotion type based on the specified acoustic features, predicted acoustic features and text features.

FIG. 9 is a block diagram of another speech synthesis apparatus according to an exemplary embodiment. As shown in FIG. 9, the speech synthesis model includes a first encoder, a second encoder and a synthesizer. The synthesis module 203 may include:

a first processing sub-module 2031, configured to extract text features corresponding to the text to be synthesized by the first encoder.

a second processing sub-module 2032, configured to extract the predicted acoustic features corresponding to the text to be synthesized by the second encoder.

a third processing sub-module 2033, configured to generate the target audio by the synthesizer based on the specified acoustic features, the predicted acoustic features and the text features.

In some embodiments, a plurality of text elements may be included in the text features. The third processing sub-module 2033 can be used for:
Step 1) Through a synthesizer, the Mel spectrum features at the current moment can be determined based on current text elements, historical Mel spectrum features, specified acoustic features and predicted acoustic features, the current text elements are the text elements input to the synthesizer at the current moment, and the historical Mel spectrum features are the Mel spectrum features at the previous moment determined by the synthesizer.
Step 2) Through the synthesizer, the target audio is generated based on the Mel spectrum features at each moment.

It should be noted that the speech synthesis model in the above embodiment is obtained by training as follows:

Step A, from training audio corresponding to training texts which do not have the specified emotion type, extracting real acoustic features corresponding to the training audio.

Step B, inputting the real acoustic features and the training texts into the speech synthesis model, and training the speech synthesis model based on the output of the speech synthesis model and the training audio.

In some embodiments, the speech synthesis model may include a first encoder, a second encoder, and a synthesizer, a blocking structure is arranged between the first encoder and the second encoder, and the blocking structure is used to prevent the second encoder from transmitting the gradient back to the first encoder.

In some embodiments, the implementation of step B may include:
Step B1, extracting the training text features corresponding to the training text by the first encoder.
Step B2, extracting the predicted training acoustic features corresponding to the training text by the second encoder.
Step B3, generating the output of the speech synthesis model by the synthesizer from the real acoustic features, the predicted training acoustic features and the training text features.

In some embodiments, the loss function of the speech synthesis model is determined by a first loss and a second loss, the first loss is determined by the output of the speech synthesis model and the training audio, and the second loss is determined by the output of the second encoder and the real acoustic features.

In some embodiments, the speech synthesis model can also be obtained by training as follows:

Step C, extracting the real Mel spectrum information corresponding to the training audio from the training audio.

Accordingly, step B can be:

taking the real acoustic features, the training text and the real Mel spectrum information as the input of the speech synthesis model, and training the speech synthesis model based on the output of the speech synthesis model and the training audio.

With regard to the apparatus in the above embodiment, the specific way in which each module performs operations has been described in detail in the embodiment of the method, and will not be explained in detail here. It should be noted that the above division of respective modules would not limit their specific implementation manners, and each module can be implemented in software, hardware, or a combination of software and hardware. In an actual implementation, the foregoing modules may be implemented as independent physical entities, or may be implemented by a single entity (for example, a processor (CPU or DSP, etc.), an integrated circuit, etc.). It shall be noted that although respective modules are shown as separate modules in the figures, one or more of the modules can be combined into one module, or further divided into multiple modules. Furthermore, indicating a module by dotted lines in the figure may indicate that the module may not actually exist, and the operation/functionality it achieve can be implemented by the apparatus itself. For example, such module indicated by dotted lines is not necessary to be included in the apparatus, such as be implemented outside of the apparatus, or can be implemented by any other device than the apparatus which will notify the result to the apparatus,

To sum up, the present disclosure first acquires the text to be synthesized and the specified emotion type, then determines corresponding specified acoustic features based on the specified emotion type, and finally inputs the text to be synthesized and the specified acoustic features into a pre-trained speech synthesis model, and the output of the speech synthesis model is the target audio with the specified emotion type corresponding to the text to be synthesized, wherein the acoustic features of the target audio match with the specified acoustic features, and the speech synthesis model is trained from the corpus without the specified emotion type. The present disclosure can control the speech synthesis of text through the acoustic features corresponding to the emotion types, so that the target audio output by the speech synthesis model can correspond to the acoustic features, and the expressive force of the target audio can be improved.

Referring to FIG. 10 below, there is illustrated a schematic structural diagram of an electronic device 300 (that is, the execution subject of the above speech synthesis method) applicable to implement the embodiments of the present disclosure. The electronic devices in the embodiments of the present disclosure may include, but not limited to, mobile terminals such as mobile phones, notebook computers, digital broadcast receivers, PDAs (personal digital assistants), PAD (tablet computers), PMP (portable multimedia players), vehicle-mounted terminals (for example, vehicle-mounted navigation terminals), etc., and fixed terminals such as digital TVs, desktop computers, and the like. The electronic device shown in FIG. 10 is only an example, and should not impose any restriction on the functions and application scopes of the embodiments of the present disclosure.

As shown in FIG. 10, the electronic device 300 can include a processing apparatus (such as a central processing unit, a graphics processor, etc.) 301, which can perform various appropriate actions and processes according to a program stored in a Read Only Memory (ROM) 302 or a program loaded into a Random Access Memory (RAM) 303 from a storage device 308. In the RAM 303, various programs and data required for the operation of the electronic device 300 are also stored. The processing device 301, ROM 302 and RAM 303 are connected to each other through a bus 304. An input/output (I/O) interface 305 is also connected to the bus 304.

Generally, the following devices can be connected to the I/O interface 305: an input device 306 including, for example, touch screen, touch pad, keyboard, mouse, camera, microphone, accelerometer, gyroscope, etc.; an output device 307 such as Liquid Crystal Display (LCD), speakers, vibrators, etc.; a storage device 308 including a magnetic tape, a hard disk, etc.; and a communication device 309. The communication device 309 may allow the electronic device 300 to communicate with other devices wirelessly or in wired so as to exchange data. Although FIG. 10 shows an electronic device 300 with various devices, it should be understood that it is not required to implement or have all the devices shown. More or fewer devices may alternatively be implemented or provided.

Particularly, according to embodiments of the present disclosure, the process described above with reference to the flowchart can be implemented as a computer software program. For example, an embodiment of the present disclosure includes a computer program product including a computer program carried on a computer readable medium, the computer program containing program code for executing the method shown in the flowchart. In such an embodiment, the computer program can be downloaded and installed from the network through the communication device 309, or installed from the storage device 308 or from the ROM 302. When executed by the processing device 301, the computer program carries out the above-mentioned functions defined in the method of the embodiment of the present disclosure.

It should be noted that the above-mentioned computer-readable medium in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or equipment, or any combination of the above. More specific examples of computer-readable storage media may include, but not limited to, an electrical connection with one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium can be any tangible medium that contains or stores a program that can be used by or in combination with an instruction execution system, device, or equipment. In this disclosure, the computer-readable signal medium may include a data signal propagated in baseband or as a part of a carrier wave, in which computer-readable program code is carried. This propagated data signal can take many forms, including, but not limited to, electromagnetic signals, optical signals, or any suitable combination of the above. The computer-readable signal medium can also be any computer-readable medium other than the computer-readable storage medium, which can send, propagate, or transmit the program for use by or in connection with the instruction execution system, apparatus, or device. The program code contained in the computer-readable medium can be transmitted by any suitable medium, including but not limited to: electric wire, optical cable, RF (radio frequency), etc., or any suitable combination of the above.

In some embodiments, the client and the server can communicate by using any currently known or future developed network protocol such as HTTP (HyperText Transfer Protocol), and can be interconnected with any form or medium of digital data communication (e.g., communication network). Examples of communication networks include a local area network (“LAN”), a wide area network (“WAN”), an internet network (e.g., the Internet) and end-to-end network (e.g., ad hoc end-to-end network), as well as any currently known or future developed networks.

The above-mentioned computer-readable medium may be included in the electronic device; or it can exist alone without being loaded into the electronic device.

The above-mentioned computer-readable medium carries one or more programs, which, when executed by the electronic device, cause the electronic device to execute the following: acquiring a text to be synthesized and a specified emotion type, determining specified acoustic features corresponding to the specified emotion type, and inputting the text to be synthesized and the specified acoustic features into a pre-trained speech synthesis model, to acquire a target audio with the specified emotion type corresponding to the text to be synthesized which is output by the speech synthesis model, wherein the acoustic features of the target audio match with the specified acoustic features, and the speech synthesis model is trained from a corpus without the specified emotion type.

Computer program codes for performing the operations of the present disclosure can be written in one or more programming languages or a combination thereof, including object-oriented programming languages such as Java, Smalltalk, and C++, as well as conventional procedural programming languages such as “C” language or similar programming languages. The program codes can be completely executed on the user's computer, partially executed on the user's computer, executed as an independent software package, partially executed on the user's computer, and partially executed on the remote computer, or completely executed on the remote computer or server. In a case related to remote computers, the remote computers can be connected to the user computers through any kind of networks, including Local Area Network (LAN) or Wide Area Network (WAN), or can be connected to external computers (for example, through the Internet with Internet service providers).

The flowcharts and block diagrams in the drawings illustrate the architecture, functions, and operations of possible embodiments of systems, methods, and computer program products according to various embodiments of the present disclosure. In this regard, each block in the flowchart or block diagram may represent a module, a program segment, or a part of the code, which contains one or more executable instructions for implementing specified logical functions. It should also be noted that in some alternative implementations, the functions labeled in the blocks may also occur in a different order than those labeled in the drawings. For example, two blocks shown in succession can actually be executed substantially in parallel, and sometimes they can be executed in the reverse order, depending on the functions involved. It should also be noted that each block in the block diagram and/or flowchart, and the combination of blocks in the block diagram and/or flowchart, can be realized by a dedicated hardware-based system that performs specified functions or operations, or can be realized by a combination of dedicated hardware and computer instructions.

The modules described in the embodiments of this disclosure can be realized by software or hardware. In some cases, the name of the module does not limit the module itself. For example, the acquisition module can also be described as “a module that acquires the text to be synthesized and the specified emotion type”.

The functions described above herein can be at least partially performed by one or more hardware logic components. For example, without limitation, exemplary types of hardware logic components that can be used include: field programmable gate array (FPGA), application specific integrated circuit (ASIC), application specific standard product (ASSP), system on chip (SOC), complex programmable logic device (CPLD) and so on.

In the context of the present disclosure, a machine-readable medium can be a tangible medium that can contain or store a program for use by or in connection with an instruction execution system, apparatus, or device. The machine-readable medium can be a machine-readable signal medium or a machine-readable storage medium. The machine-readable medium may include, but not limited to, electronic, magnetic, optical, electromagnetic, infrared, or semiconductor systems, devices or equipment, or any suitable combination of the foregoing. More specific examples of machine-readable storage medium may include electrical connections based on one or more wires, portable computer disks, hard disks, random access memories (RAM), read-only memories (ROM), erasable programmable read-only memories (EPROM or flash memories), optical fibers, compact disk read-only memories (CD-ROMs), optical storage devices, magnetic storage devices, or any suitable combination of the above.

According to one or more embodiments of the present disclosure, exemplary embodiment 1 provides a speech synthesis method, comprising: acquiring a text to be synthesized and a specified emotion type, determining specified acoustic features corresponding to the specified emotion type, and inputting the text to be synthesized and the specified acoustic features into a pre-trained speech synthesis model, to acquire a target audio with the specified emotion type corresponding to the text to be synthesized which is output by the speech synthesis model, wherein the acoustic features of the target audio match with the specified acoustic features, and the speech synthesis model is trained from a corpus without the specified emotion type.

According to one or more embodiments of the present disclosure, exemplary embodiment 2 provides the method of exemplary embodiment 1, wherein the specified acoustic features include at least one of fundamental frequency, volume and speech speed, and the determining specified acoustic features corresponding to the specified emotion type comprises: determining the corresponding specified acoustic features based on the specified emotion type and preset association relationships between emotion types and acoustic features.

According to one or more embodiments of the present disclosure, exemplary embodiment 3 provides the method of exemplary embodiment 1 or 2, wherein the speech synthesis model can be configured to: obtain text features corresponding to the text to be synthesized and predicted acoustic features corresponding to the text to be synthesized from the text to be synthesized; obtain target audio with the specified emotion type based on the specified acoustic features, predicted acoustic features and text features.

According to one or more embodiments of the present disclosure, exemplary embodiment 4 provides the method of exemplary embodiment 3, wherein the speech synthesis model includes a first encoder, a second encoder and a synthesizer, and the inputting the text to be synthesized and the specified acoustic features into a pre-trained speech synthesis model, to acquire a target audio with the specified emotion type corresponding to the text to be synthesized which is output by the speech synthesis model, comprises: extracting text features corresponding to the text to be synthesized by the first encoder; extracting the predicted acoustic features corresponding to the text to be synthesized by the second encoder; and generating the target audio by the synthesizer based on the specified acoustic features, the predicted acoustic features and the text features.

According to one or more embodiments of the present disclosure, exemplary embodiment 5 provides the method of exemplary embodiment 4, wherein the text features include a plurality of text elements, and generating the target audio by the synthesizer based on the specified acoustic features, the predicted acoustic features and the text features, comprises: determining the Mel spectrum features at the current moment through a synthesizer based on current text elements, historical Mel spectrum features, specified acoustic features and predicted acoustic features, the current text elements are the text elements input to the synthesizer at the current moment, and the historical Mel spectrum features are the Mel spectrum features at the previous moment determined by the synthesizer; and generating the target audio through the synthesizer based on the Mel spectrum features at each moment.

According to one or more embodiments of the present disclosure, exemplary embodiment 6 provides the method of exemplary embodiment 3, wherein the speech synthesis model is trained by: from training audio corresponding to training texts which do not have the specified emotion type, extracting real acoustic features corresponding to the training audio; inputting the real acoustic features and the training texts into the speech synthesis model, and training the speech synthesis model based on the output of the speech synthesis model and the training audio.

According to one or more embodiments of the present disclosure, exemplary embodiment 7 provides the method of exemplary embodiment 6, wherein the speech synthesis model may include a first encoder, a second encoder, and a synthesizer, a blocking structure is arranged between the first encoder and the second encoder, and the blocking structure is used to prevent the second encoder from transmitting the gradient back to the first encoder; the inputting the real acoustic features and the training texts into the speech synthesis model, and training the speech synthesis model based on the output of the speech synthesis model and the training audio, comprises: extracting the training text features corresponding to the training text by the first encoder; extracting the predicted training acoustic features corresponding to the training text by the second encoder; and generating the output of the speech synthesis model by the synthesizer from the real acoustic features, the predicted training acoustic features and the training text features.

According to one or more embodiments of the present disclosure, exemplary embodiment 8 provides the method of exemplary embodiment 6, wherein the loss function of the speech synthesis model is determined by a first loss and a second loss, the first loss is determined by the output of the speech synthesis model and the training audio, and the second loss is determined by the output of the second encoder and the real acoustic features.

According to one or more embodiments of the present disclosure, exemplary embodiment 9 provides the method of exemplary embodiment 6, wherein the speech synthesis model is further trained by: extracting the real Mel spectrum information corresponding to the training audio from the training audio; and the inputting the real acoustic features and the training texts into the speech synthesis model, and training the speech synthesis model based on the output of the speech synthesis model and the training audio, comprises: taking the real acoustic features, the training text and the real Mel spectrum information as the input of the speech synthesis model, and training the speech synthesis model based on the output of the speech synthesis model and the training audio.

According to one or more embodiments of the present disclosure, exemplary embodiment 10 provides a speech synthesis apparatus, comprising: an acquisition module configured to acquire a text to be synthesized and a specified emotion type, a determination module configured to determine specified acoustic features corresponding to the specified emotion type, and a synthesis module configured to input the text to be synthesized and the specified acoustic features into a pre-trained speech synthesis model, to acquire a target audio with the specified emotion type corresponding to the text to be synthesized which is output by the speech synthesis model, wherein the acoustic features of the target audio match with the specified acoustic features, and the speech synthesis model is trained from a corpus without the specified emotion type.

According to one or more embodiments of the present disclosure, exemplary embodiment 11 provides a computer readable medium on which a computer program is stored, which, when executed by a processing device, realizes the steps of the methods described in exemplary embodiments 1 to 9.

According to one or more embodiments of the present disclosure, exemplary embodiment 12 provides an electronic device, including a storage device on which a computer program is stored; a processing device for executing the computer program in the storage device to realize the steps of the methods described in exemplary embodiments 1 to 9.

The above description is only the preferred embodiment of the present disclosure and the explanation of the applied technical principles. Those skilled in the art should understand that the disclosure scope involved in this disclosure is not limited to the technical solution formed by the specific combination of the above technical features, but also covers other technical solutions formed by any combination of the above technical features or their equivalent features without departing from the above disclosed concept. For example, the above features can be mutually replaced with the technical features with similar functions disclosed in this disclosure (but not limited to).

Furthermore, although the operations are depicted in a particular order, this should not be understood as requiring these operations to be performed in the particular order shown or in sequential order. Under certain circumstances, multitasking and parallel processing may be beneficial. Similarly, although the above discussion contains a number of specific implementation details, these should not be interpreted as limitations on the scope of the present disclosure. Some features described in the context of separate embodiments can also be implemented in a single embodiment in combination. On the contrary, various features described in the context of a single embodiment can also be implemented in multiple embodiments individually or in any suitable sub-combination.

Although the subject matter has been described in language specific to structural features and/or logical acts of methods, it should be understood that the subject matter defined in the appended claims is not necessarily limited to the specific features or acts described above. On the contrary, the specific features and actions described above are only exemplary forms of implementing the claims. With regard to the apparatus in the above embodiment, the specific way in which each module performs operations has been described in detail in the embodiment of the method, and will not be explained in detail here.

1. A speech synthesis method, comprising:
acquiring a text to be synthesized and a specified emotion type,
determining specified acoustic features corresponding to the specified emotion type, and
inputting the text to be synthesized and the specified acoustic features into a pre-trained speech synthesis model, to acquire a target audio with the specified emotion type corresponding to the text to be synthesized which is output by the speech synthesis model.

2. The method of claim 1, wherein acoustic features of the target audio match with the specified acoustic features, and the speech synthesis model is trained from a corpus without the specified emotion type.

3. The method of claim 1, wherein the specified acoustic features include at least one of fundamental frequency, volume and speech speed, and the determining the specified acoustic features corresponding to the specified emotion type comprises:
determining the corresponding specified acoustic features based on the specified emotion type, and association relationships between emotion types and acoustic features.

4. The method of claim 1, wherein the speech synthesis model is used to:
obtain text features corresponding to the text to be synthesized and predicted acoustic features corresponding to the text to be synthesized from the text to be synthesized;
obtain the target audio with the specified emotion type based on the specified acoustic features, predicted acoustic features and text features.

5. The method of claim 4, wherein the specified acoustic features and the predicted acoustic features are superimposed to obtain an acoustic feature vector, and then the target audio is generated based on the acoustic feature vector and the text vector.

6. The method of claim 4, wherein the specified acoustic feature, the predicted acoustic feature and the text vector are superimposed to obtain a combined vector, and then the target audio is generated based on the combined vector.

7. The method of claim 1, wherein the speech synthesis model includes a first encoder, a second encoder and a synthesizer;
the inputting the text to be synthesized and the specified acoustic features into a pre-trained speech synthesis model, to acquire a target audio with the specified emotion type corresponding to the text to be synthesized which is output by the speech synthesis model, comprises:
extracting text features corresponding to the text to be synthesized by the first encoder;
extracting the predicted acoustic features corresponding to the text to be synthesized by the second encoder; and
generating the target audio by the synthesizer based on the specified acoustic features, the predicted acoustic features and the text features.

8. The method of claim 7, wherein the text features include a plurality of text elements, and the generating the target audio by the synthesizer based on the specified acoustic features, the predicted acoustic features and the text features, comprises:
determining Mel spectrum features at the current moment through the synthesizer based on current text elements, historical Mel spectrum features, the specified acoustic features and the predicted acoustic features, wherein the current text elements are text elements in the text features input to the synthesizer at the current moment, and the historical Mel spectrum features are Mel spectrum features at the previous moment determined by the synthesizer; and
generating the target audio through the synthesizer based on the Mel spectrum features at each moment.

9. The method of claim 1, wherein the speech synthesis model is trained by:
from training audio corresponding to training texts which do not have the specified emotion type, extracting real acoustic features corresponding to the training audio;
inputting the real acoustic features and the training texts into the speech synthesis model, and training the speech synthesis model based on the output of the speech synthesis model and the training audio.

10. The method of claim 9, wherein the speech synthesis model includes a first encoder, a second encoder, and a synthesizer, a blocking structure is arranged between the first encoder and the second encoder, and the blocking structure is used to prevent the second encoder from transmitting the gradient back to the first encoder;
the inputting the real acoustic features and the training texts into the speech synthesis model, and training the speech synthesis model based on the output of the speech synthesis model and the training audio, comprises:
extracting the training text features corresponding to the training text by the first encoder;
extracting the predicted training acoustic features corresponding to the training text by the second encoder; and
generating the output of the speech synthesis model by the synthesizer from the real acoustic features, the predicted training acoustic features and the training text features.

11. The method of claim 10, wherein the loss function of the speech synthesis model is determined by a first loss and a second loss, the first loss is determined by the output of the speech synthesis model and the training audio, and the second loss is determined by the output of the second encoder and the real acoustic features.

12. The method of claim 11, wherein the loss function of the speech synthesis model is determined by weighted summation of the first loss and the second loss.

13. The method of claim 1, wherein the speech synthesis model is further trained by:
extracting the real Mel spectrum information corresponding to the training audio from the training audio; and
the inputting the real acoustic features and the training texts into the speech synthesis model, and training the speech synthesis model based on the output of the speech synthesis model and the training audio, comprises:
taking the real acoustic features, the training text and the real Mel spectrum information as the input of the speech synthesis model, and training the speech synthesis model based on the output of the speech synthesis model and the training audio.

14-16. (canceled)

17. A non-transitory computer readable medium on which a computer program is stored, wherein the program, when executed by a processing device, implements operations comprising:
acquiring a text to be synthesized and a specified emotion type;
determining specified acoustic features corresponding to the specified emotion type; and
inputting the text to be synthesized and the specified acoustic features into a pre-trained speech synthesis model, to acquire a target audio with the specified emotion type corresponding to the text to be synthesized which is output by the speech synthesis model.

18. An electronic device, comprising:
a storage device on which a computer program is stored;
a processing device configured to execute the computer program in the storage device to implement operations comprising:
acquiring a text to be synthesized and a specified emotion type;
determining specified acoustic features corresponding to the specified emotion type; and
inputting the text to be synthesized and the specified acoustic features into a pre-trained speech synthesis model, to acquire a target audio with the specified emotion type corresponding to the text to be synthesized which is output by the speech synthesis model.

19. (canceled)

20. The electronic device of claim 18, wherein the speech synthesis model is used to:
obtain text features corresponding to the text to be synthesized and predicted acoustic features corresponding to the text to be synthesized from the text to be synthesized;
obtain the target audio with the specified emotion type based on the specified acoustic features, predicted acoustic features and text features.

21. The electronic device of claim 18, wherein the speech synthesis model includes a first encoder, a second encoder and a synthesizer;
the inputting the text to be synthesized and the specified acoustic features into a pre-trained speech synthesis model, to acquire a target audio with the specified emotion type corresponding to the text to be synthesized which is output by the speech synthesis model, comprises:
extracting text features corresponding to the text to be synthesized by the first encoder;
extracting the predicted acoustic features corresponding to the text to be synthesized by the second encoder; and
generating the target audio by the synthesizer based on the specified acoustic features, the predicted acoustic features and the text features.

22. The electronic device of claim 21, wherein the text features include a plurality of text elements, and the generating the target audio by the synthesizer based on the specified acoustic features, the predicted acoustic features and the text features, comprises:
determining Mel spectrum features at the current moment through the synthesizer based on current text elements, historical Mel spectrum features, the specified acoustic features and the predicted acoustic features, wherein the current text elements are text elements in the text features input to the synthesizer at the current moment, and the historical Mel spectrum features are Mel spectrum features at the previous moment determined by the synthesizer; and
generating the target audio through the synthesizer based on the Mel spectrum features at each moment.

23. The non-transitory computer readable medium of claim 17, wherein the speech synthesis model includes a first encoder, a second encoder and a synthesizer;
the inputting the text to be synthesized and the specified acoustic features into a pre-trained speech synthesis model, to acquire a target audio with the specified emotion type corresponding to the text to be synthesized which is output by the speech synthesis model, comprises:
extracting text features corresponding to the text to be synthesized by the first encoder;
extracting the predicted acoustic features corresponding to the text to be synthesized by the second encoder; and
generating the target audio by the synthesizer based on the specified acoustic features, the predicted acoustic features and the text features.

24. The non-transitory computer readable medium of claim 23, wherein the text features include a plurality of text elements, and the generating the target audio by the synthesizer based on the specified acoustic features, the predicted acoustic features and the text features, comprises:
determining Mel spectrum features at the current moment through the synthesizer based on current text elements, historical Mel spectrum features, the specified acoustic features and the predicted acoustic features, wherein the current text elements are text elements in the text features input to the synthesizer at the current moment, and the historical Mel spectrum features are Mel spectrum features at the previous moment determined by the synthesizer; and
generating the target audio through the synthesizer based on the Mel spectrum features at each moment.
